(19) United States
(12) Patent Application Publication
(10) Pub. No.: US 2017/0137067 A1
(43) Pub. Date: May 18, 2017

(54) REAR BODY MODULE

(71) Applicant: BASF SE, Ludwigshafen (DE)

(72) Inventors: Uwe WOLF, Starnberg (DE); Jan Kurt Walter SANDLER, Heidelberg (DE); Alex HORISBERGER, Ludwigshafen (DE); Tobias NACHTIGAELLER, Heidelberg (DE)

(73) Assignee: BASF SE, Ludwigshafen (DE)

(21) Appl. No.: 15/317,252

(22) PCT Filed: Jun. 10, 2015
(86) PCT No.: PCT/EP2015/062908

§ 371 Date: Dec. 8, 2016

(30) Foreign Application Priority Data
Jun. 11, 2014 (EP) 14171961.7

(51) Int. Cl. B62D 25/08; B60K 1/04; B62D 25/02; B62D 25/04; B62D 25/20

(52) U.S. Cl. CPC B62D 25/08; B62D 25/04; B62D 25/2036; B62D 25/2027; B62D 25/025; B60K 1/04; B62D 29/007

(57) ABSTRACT

The invention concerns a rear body module, comprising:
a floor panel (1) with at least one mounting (3) for a rear seat and also an upwardly extending rear termination (13), depressions (9) and elevations (11) being formed in the floor panel (1) for strengthening, and
a left-hand and a right-hand support (19, 21), which in each case form a C pillar of the vehicle body and fork at their upper end into at least two rails (25, 27), the rails (25, 27) being respectively connected to a rear roof rail (23), and the roof rails (23) being connected to one another by a cross member (29), a reinforcing strut (31) respectively emerging from the cross member (29) and being coupled to the roof rail (23).

The invention concerns a rear body module, comprising a floor panel and also a left-hand and a right-hand support, which in each case form a C pillar of the vehicle body, are connected to the floor panel and respectively end in a roof rail. The roof rails are connected to one another by a cross member.

A vehicle body usually comprises a front module, in which for example the engine of the motor vehicle is accommodated, a central module, with the passenger seats, and a rear module, for example in the case of a limousine the trunk or in the case of a station wagon the loading area.

Vehicle bodies are usually produced from steel, the vehicle body having a supporting floor structure, which in the area of the central body module is produced as a floor panel. On the floor panel, the seats for the driver and front passenger are then later mounted, and optionally a rear bench seat. In the case of modern motor vehicles, the side modules of the motor vehicle, for example fenders, A, B and C pillars, are attached laterally to the supporting structure. The A, B and C pillars are connected to one another by cross members and bear the vehicle roof. Furthermore, there are usually roof rails between the A pillar and the B pillar and also between the B pillar and the C pillar. The individual components of the vehicle body are usually welded to one another and, to provide them with sufficient corrosion resistance, must be subsequently provided with a coating in a laborious process. Moreover, cavities must be sealed, in order that no water, and in particular corrosive salt, can get in.

In order to save energy for moving the motor vehicle, efforts are currently being made to reduce the weight of the vehicle. This is possible for example by using materials with lower density than steel, for example plastics. Particularly non-load-bearing components are currently being produced from plastics. A further disadvantage of the present structure of motor vehicle bodies is that great amounts of material are required to achieve sufficient stability, likewise leading to greater weight.

It is therefore an object of the present invention to provide a rear body module that is configured to allow a lower weight to be achieved than in the case of conventional rear body modules on the basis of material savings, the omission of components and the choice of materials, and which can be connected in an easy way to a central body module.

The object is achieved by a rear body module, comprising:
a floor panel with at least one mounting for a rear seat and also an upwardly extending rear termination, depressions and elevations being formed in the floor panel for strengthening, and
a left-hand and a right-hand support, which in each case form a C pillar of the vehicle body and fork at their upper end into at least two rails, the rails being respectively connected to a rear roof rail, and the roof rails being connected to one another by a cross member, a reinforcing strut respectively emerging from the cross member and being coupled to the roof rail.

According to the invention, the floor panel, supports, roof rails, rails and/or reinforcing struts may be integrated in the rear body module in one piece or as multiple parts.

The integration of the floor panel, supports, roof rails, rails and/or reinforcing struts achieves an additional stiffening of the rear body module, so that additional material for reinforcing elements on the rear body module can be saved. Moreover, this allows the creation of a stable rear body module, which can then be connected in an easy way to a central body module. This allows the separate production of the rear body module, central body module and front body module. A modular structure of the vehicle body is made possible as a result, so that any desired front modules, central modules and rear modules can be combined with one another, as long as the dimensions at the connecting points of the front module to the central module and from the central module to the rear module coincide.

A further advantage is that, apart from the material saving, alternative materials can also be used. Corresponding alternative materials are, for example, polymer materials. These allow a further weight reduction of the rear body module. Within the scope of the present invention, polymer materials comprise not only unreinforced polymers but also reinforced polymers and composite materials that comprise a polymer matrix.

Depending on the vehicle concept, the rear body module may also comprise a mounting for a drive unit for the motor vehicle. Corresponding drive units are, for example, internal combustion engines or else a central electric motor. In the case of motor vehicles that are driven for example by axle-hub motors or in which the drive module is positioned in the front region of the vehicle, the rear body module may also comprise a luggage compartment or else, for example, mountings for batteries. For this purpose it is possible for example to provide rear fenders and a correspondingly movable cover, which is usually referred to as the trunk lid, or alternatively a tailgate. In addition, it would be possible to design the floor panel in such a way that it also forms the floor of the trunk thus formed or else the engine compartment for a rear engine. The fenders may in this case likewise be connected in one piece to the supports forming the C pillars and to the floor panel. Alternatively, it is also possible to provide separate add-on parts here. If the floor panel, fenders and trunk lid or tailgate are provided as separate parts, the rear body module represents the rear termination of the passenger compartment of the motor vehicle. It is preferred, however, if the rear body module comprises all of the load-bearing parts for the rear part of the body. Non-load-bearing parts, for example fenders placed on corresponding supports or the trunk lid or the tailgate, may then be correspondingly attached in a modular manner and also be exchangeably fitted, for example by corresponding mounting, for example by clipping, so that in this way an easy modification of the motor vehicle is possible.

Suitable rails may be provided for example as supports for the drive unit or trunk and for fastening fenders. These rails may be integrally connected to the rear body module or alternatively releasably connected to it. An integral, positive connection, for example by adhesive bonding or welding, is preferred however. Alternatively, a nonpositive connection, for example by riveting or screwing, would also be possible.

If the rear body module is to be used for an electrically driven vehicle, it is necessary to accommodate battery modules for storing the electrical energy. For this purpose it is possible for example to form a depression for receiving a battery module under the mounting for the rear seat. In this case, a battery module can then be positioned in the mounting. The position of the battery module in the depression in the floor panel under the mounting for the rear seat serves for protection of the battery. The use of the depression under the rear seat as an installation space for a battery module allows the vehicle to be fitted with battery modules in accordance with the range requirement. Thus, in the case of a low range requirement, fewer battery modules may be provided, whereby the installation space in which no battery modules are fitted can be used as an additional stowage space. Moreover, by reducing the number of battery modules, the weight of the vehicle is reduced, and consequently also the energy demand.

As an alternative to the depression under the mounting, it is also possible to mount a holder for a battery module under the floor panel. In order in this case to obtain protection for the battery module, it is preferred to provide in addition to the floor panel of the rear body module, after the assembly of the entire body, a further floor panel, which offers the required protection and extends over the entire underside of the body. Such a separate floor panel may of course also be used if the battery modules are accommodated in depressions in the floor panel. In comparison with the depressions in the floor panel, the holders under the floor panel have the advantage that the battery modules can also be exchanged when the rear seats have been fitted.

According to the invention, it is possible to provide a rear bench seat or else individual seats in the rear body module. If individual seats are provided, it is possible for example to form two mountings in the floor panel, each for a rear seat, and to fit a seat shell on each mounting.

If the rear seats are not required for passenger transport, it is possible in an embodiment of the invention to remove the rear seats and to fit a transportation box on the mounting for the rear seat. This allows an additional load to be safely transported. The transportation box may in this case be designed in such a way that there is still space under the transportation box for the installation of a battery module, which is advantageous in particular whenever a great range is required, and therefore a correspondingly great amount of electrical energy has to be provided. If it is possible to dispense with an additional battery module under the transportation box, for example when only a short distance has to be covered, the transportation box may be designed in such a way that it also makes use of the space in the depression of the floor panel that was intended for the battery module. It is of course alternatively also possible to fit in the depression a second transportation box under the transportation box fitted on the mounting for the rear seat.

To make it easily possible to exchange complete rear seats, seat shells or transportation boxes that are fitted on the mounting for rear seats, it is particularly advantageous if the rear seats, seat shells or transportation boxes are fastened for example by latching connectors in the mounting for rear seats. This allows for example a rear seat to be quickly exchanged for a transportation box.

In one embodiment of the invention, between a support and the roof rail there respectively extends a further rail, to which a backrest of the rear seat is fastened. The further rail and the backrest fastened thereto of the rear seat have the effect of further increasing the stability of the rear body module. The backrest may in this case either be upholstered or be formed as a shell in which a backrest padding is subsequently suspended. It is also possible in the case of a one-part seat to connect the backrest of the seat during assembly to the rail for fastening the backrest. If the backrest is fastened to the rail, it is however preferred to design the rear seat in two parts, to fasten the backrest securely to the rail and a separate seat shell in the mounting for the rear seat on the floor panel. For this case, the transportation box may be designed in such a way that it is fitted before the backrest, so that the backrest does not have to be removed for the transportation box to be fitted. If the backrest does not need to be removed, it may also be connected as one part to the rail, for example by welding or adhesive bonding. This is advisable in particular whenever the backrest also contributes to the stiffening of the rear body module.

In a particularly preferred embodiment, the floor panel, supports, roof rails, rails and/or reinforcing struts are produced from a material comprising plastic. Suitable materials comprising plastic are, in particular, fiber-reinforced plastics, organometallic sheets or sandwich structures.

Corresponding sandwich structures are made up for example of an upper and a lower sheet and also a polymer foam incorporated between the sheets or a honeycomb structure incorporated between the sheets. The sheets may for example be produced from a fiber-reinforced plastic or metal. It is particularly preferred if the upper and the lower sheet are in each case an organometallic sheet.

If a fiber-reinforced plastic is used for producing the floor panel, supports, roof rails, rails and/or reinforcing struts, a thermoplastic-based fiber-reinforced plastic is used particularly preferably as the matrix material. The fibers that are used may be short fibers, long fibers or continuous fibers. If the fibers are used in the form of continuous fibers, it is possible to use them as laid, knitted or woven structures or else in a random form. If the continuous fibers are used in the form of laid, woven or knitted structures, it is possible to position multiple layers of fibers one on top of the other. In the case of laid fiber structures, the fibers of the individual layers may be turned in relation to one another.

It is particularly preferred for the fibers to be used in the form of laid structures.

Suitable for example as the material for the fibers are glass fibers, carbon fibers, potassium titanate fibers, basalt fibers or aramid fibers. Suitable in particular as the polymer material for the matrix of such fiber-reinforced plastics are polyamides (PA), polyurethane (PU), polypropylene (PP) or polybutylene terephthalate (PBT). Polyamides or polyurethane are particularly preferred here. Alternatively, the polymer material may also be a thermosetting plastic. In this case, the plastic is with particular preference an epoxy resin.

An additional reinforcement can be achieved by a wire mesh being introduced into the individual components, in particular the floor panel, the supports and/or the rails. The wire of the wire mesh is in this case preferably produced from a metal. Suitable metals for this are, for example, steel, aluminum or magnesium. Steel is used with particular preference as the metal.

If the floor panel, supports, roof rails, rails and/or reinforcing struts are produced from a sandwich structure, in particular in the form of a two-shell structure with a foam introduced in between, or alternatively also completely from a metal, the metal is preferably selected from steel, aluminum or magnesium.

However, fiber-reinforced polymers are also preferred for the two-shell structure.

The foam that is introduced between the two shells of fiber-reinforced plastic or metal in the case of a two-shell structure, i.e. a sandwich structure, is preferably a polymer foam. Suitable polymer foams are, for example, closed-cell or open-cell foams on the basis of polyurethane (PU), polyether sulfone (PES), polyamide (PA), polybutylene terephthalate (PBT) or polyester.

Suitable as material for the honeycomb structure in the case of a two-shell structure are reinforced or unreinforced polymers, in particular thermoplastic polymers. Suitable polymers are likewise for example polyamide, polyurethane, polypropylene or polybutylene terephthalate. Suitable as material for the reinforcement are in particular short fibers or long fibers, it being possible to use as the material the fiber materials described above in connection with the fiber-reinforced polyamide for the floor panel, supports, roof rails, rails and/or reinforcing elements. As an alternative to polymers as the material, the honeycomb structure may also be produced from paper, paperboard or card.

In particular with regard to the structure of the floor panel, a one-part structure is alternatively also possible, for example of fiber-reinforced plastic or metal, preferably with local rib reinforcement. The local rib reinforcement serves for increasing the torsional stiffness of the floor panel.

Side sills, which may for example be produced as two hollow shells of fiber-reinforced plastic or metal, are preferably integrated in the floor panel. It is alternatively also possible to configure the side sills as two shells of fiber-reinforced plastic or metal with a foam core. In addition, it is possible to provide the side sills with a local wire reinforcement, in order to increase the stability of the side sills.

In order to obtain a one-piece structure comprising the floor panel, supports, roof rails, rails and/or reinforcing struts, they are preferably positively connected to one another. Particularly preferably, the floor panel, supports, roof rails, rails and/or reinforcing struts are welded to one another. Apart from welded connections, however, it is alternatively also possible to adhesively bond the individual parts to one another. Alternatively, they may also be nonpositively connected to one another, for example by riveting or screwing.

For the production of a vehicle as a whole, the rear body module is then connected to a central module and a front module. The rear body module is configured here in such a way that the central body module can be positively connected to the rear body module, for example by welding or adhesive bonding. A nonpositive connection of the rear body module and the central body module, for example by screwing or riveting, would also be possible.

In the case of a positive connection of the rear body module and the central body module, it is preferred in particular if they are adhesively bonded to one another.

Exemplary embodiments of the invention are represented in the figures and are explained in more detail in the description that follows.

### IN THE FIGURES

FIG. 1 shows a floor panel for a rear body module,

FIG. 2 shows a three-dimensional representation of a rear body module with installed rear seats,

FIG. 3 shows a three-dimensional representation of a rear body module with an installed transportation box.

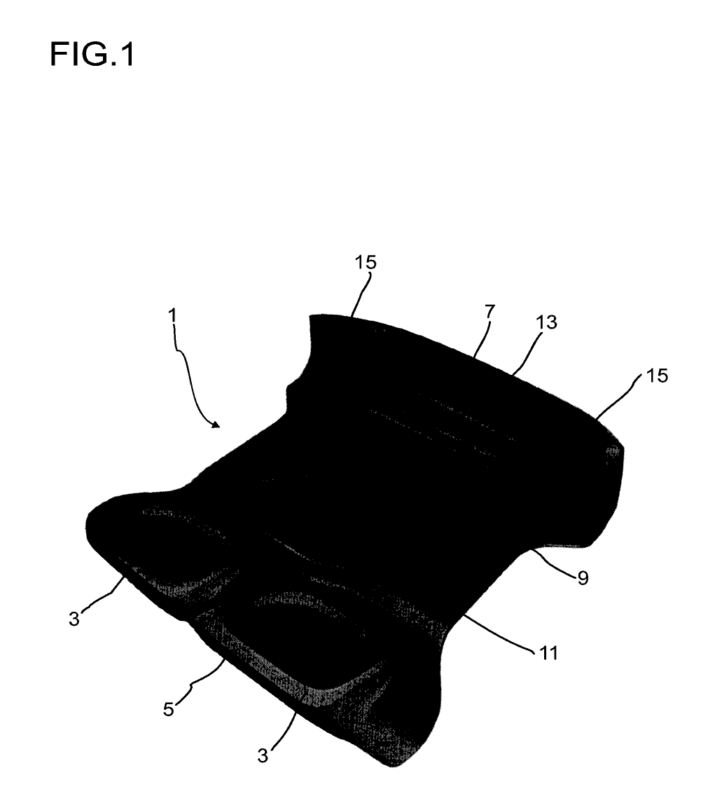

In FIG. 1, a floor panel for a rear body module is represented.

A floor panel 1 is made up of a sheet-like material, for example a metal sheet or an organometallic sheet. Alternatively and with preference, a sandwich structure, which comprises an upper and a lower sheet, for example as a metal sheet or preferably as an organometallic sheet, between which a polymer foam or a honeycomb structure is incorporated, is used for the floor panel.

In the embodiment represented here, the floor panel 1 has two mountings 3 for rear seats. Apart from the configuration with two mountings 3 for rear seats, only one mounting is also possible, in which not individual seats but a rear bench seat is then fitted. The mountings 3 for rear seats may also be configured in such a way that they can be used for receiving battery modules. For this purpose, it is possible for example to configure the mountings 3 for rear seats in the form of depressions in the floor panel.

The front termination 5 of the floor panel 1 is configured in such a way that it can be connected to a floor panel of a central body module. The connection may in this case be realized for example by welding, adhesive bonding, screwing or riveting, the type of connection being dependent on the material of the floor panel 1. If polymer-based materials are used for the floor panel, welding or adhesive bonding is preferred; in the case of metallic materials, welding is preferred.

Behind the mountings 3 for the rear seats there is a rear portion 7, which can be used for example as a trunk floor. Alternatively in the case of rear-driven vehicles, the region may also be used for receiving an engine. For reinforcement, the floor panel 1 has in the rear portion 7 depressions 9 and elevations 11, which serve for stiffening the floor panel 1. The depressions 9 and elevations 11 may in this case assume any suitable form, for example as represented here with a central branch that forks into smaller branches. The form may in this case accommodate for example other forms of the load-bearing structures of the vehicle body.

The rear portion 7 is adjoined by a rear region 13, which is aligned perpendicularly in relation to the floor and in which for example mountings 15 for rear lights are formed. Alternatively or in addition to the mountings 15 for rear lights, further mountings for the installation of vehicle parts or accessories may also be formed in the rear region 13.

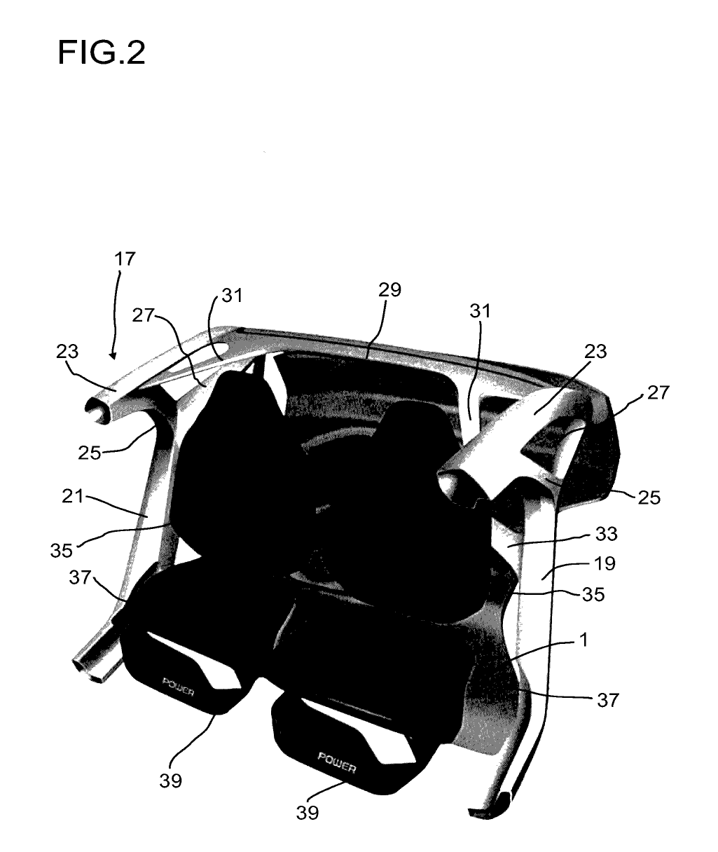

FIG. 2 shows a three-dimensional representation of a rear body module with installed rear seats.

For the production of a rear body module 17, the floor panel 1 is connected to a left-hand support 19 and a right-hand support 21. The terms “left” and “right” are used here in each case as seen in the traveling direction. The left-hand support 19 and the right-hand support 21 at the same time form the C pillars of the vehicle body. If the rear body module 17 is used for constructing a vehicle with 4 doors, the form of the left-hand support 19 and of the right-hand support 21 preferably corresponds to the form of the rear doors, so that the left-hand support 19 and the right-hand support 21 are in each case part of a door frame.

The upper termination of the supports 19, 21 is respectively formed by a roof rail 23. In order that the roof rail 23 can be respectively connected to the left-hand support 19 and the right-hand support 21 in a torsionally stiff manner, it is preferred—as represented here—if the left-hand support 19 and the right-hand support 21 respectively fork into a front rail 25 and a rear rail 27 and the roof rails 23 are connected to the rails 25, 27.

To complete the rear body module 17, the two roof rails 23 are connected to one another by a cross member 29. Here too, an additional torsional stiffness can be achieved by a reinforcing strut 31 emerging from the cross member 29 and likewise being connected to the roof rail 23.

In order to ensure sufficient stability, it is preferred to configure the supports 19, 21, the roof rail 23, the rails 25, 27, the cross member 29 and the reinforcing struts 31 as a hollow profile, an optionally reinforced polymer material preferably being used as the material. In this case, the hollow profile may also be made up of a sandwich material which comprises an upper and a lower sheet with a polymer foam incorporated in between.

In order to increase the torsional stiffness of the rear body module further, it is preferred to attach to the left-hand support 19 and the right-hand support 21 a rail 33, to which a backrest 35 for the rear seat is fastened. The rail 33 may in this case extend for example between the left-hand support 19 and the right-hand support 21 or else run from the left-hand support 19 or from the right-hand support 21 respectively to the cross member 29. In order to keep the vehicle weight down as much as possible, it is preferred if the backrest is configured with an integrated head restraint. Of course, it is however also possible to provide adjustable head restraints.

In the embodiment represented in FIG. 2, seat shells 37 are respectively fitted on the mountings 3 for a rear seat. The seat shells preferably have in this case an upholstery. The seat shell 37 and the backrest 35 then form the complete rear seat.

As an alternative to a two-part rear seat, such as that represented here, it is also possible to install a one-part rear seat with a seat surface and a backrest. In particular whenever the backrest 35 is used for additional stabilization of the rear body module, however, it is preferred to provide two-part rear seats.

Apart from the embodiment represented here with two individual rear seats, it is alternatively also possible to provide a rear bench. In this case, the backrest and the seat surface respectively extend over the entire width of the rear body module.

In the embodiment represented here, mountings 39 for battery modules are provided under the seat shells 39. Then, depending on the demand and desired range of the vehicle, if it is electrically driven, additional battery modules can be fitted in the mountings 39.

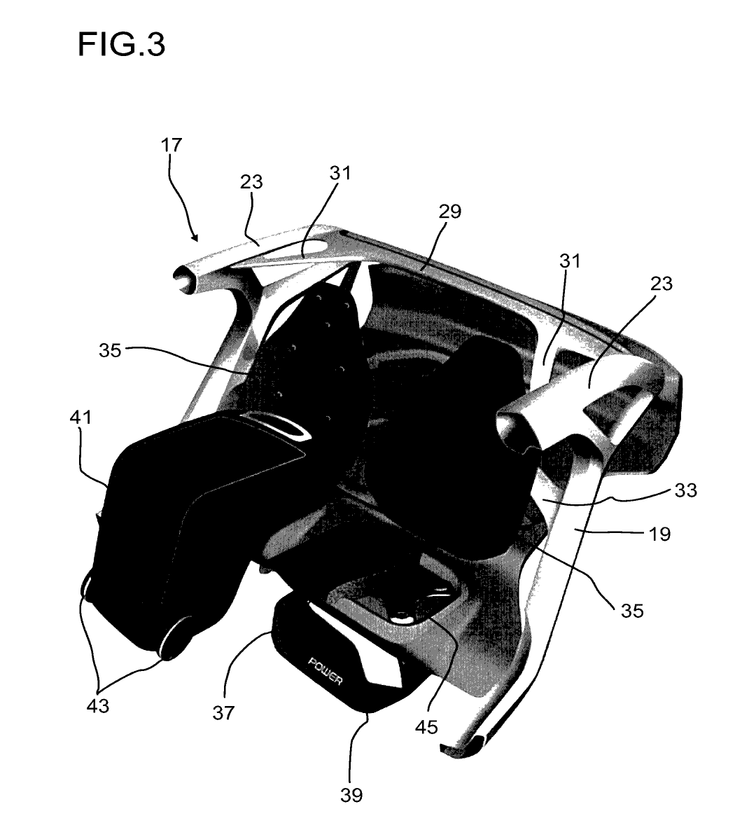

FIG. 3 shows a three-dimensional representation of a rear body module with an installed transportation box.

The embodiment represented in FIG. 3 differs from that represented in FIG. 2 in that a transportation box 41 is provided at the position of the right-hand rear seat. For the fastening of the transportation box 41, the seat shell 37 has been removed from the mounting 3 for the rear seat. In addition, the upholstery of the backrest 35 has also been removed. The removal of the upholstery of the backrest 35 allows further stowage space to be gained. In order that the transportation box 41 can be safely taken along in the vehicle, it is preferably firmly connected to a mounting 43 for the seat shell 37. Easy installation and removal of the transportation box 41 can be realized for example by using latching elements for the fastening.

In order to be able to transport the transportation box 41 easily outside the vehicle, it is possible for example to provide the transportation box 41 with rollers 43, on which it can then be pulled and pushed.

If, as represented in FIGS. 2 and 3, a mounting 39 is used for a battery module that is fitted under the respective seat shell 37, it is advantageous, as shown here by a seat shell 37 represented in section, to fit a seat cross member 45 in the mounting 3 for the seat shell 37 and to screw the mounting 39 for the battery module to the seat cross member 45 through the floor panel 1. In this way, the mounting 39 for the battery module is firmly connected in the rear body module 17 and the battery module can be fitted when required into the mounting 39 in an easy way.

If the supports 19, 21, the roof rails 23 and the cross member 29 are configured as hollow profiles, it is possible to lay lines required for the vehicle through the hollow profiles. Furthermore, it is also possible to use the hollow profiles as channels for feeding in fresh air. In this case, ventilation outlets through which fresh air can flow into the passenger compartment may be provided at desired positions in the hollow profile. The ventilation outlets may in this case be openings, it being possible for the openings to be embodied in any configuration desired. For example, it is possible to provide a large number of small openings or else several larger openings. Any configuration desired is possible here. In particular, it is possible for example to configure the outlet openings for fresh air in the course of additive manufacturing. This also makes it possible for example to realize complex 3D grid structures, which make diffuse ventilation possible or by which different ventilation zones can be implemented in the passenger compartment.

### LIST OF DESIGNATIONS

1 floor panel
3 mounting for rear seat
5 front termination of the floor panel 1
7 rear portion
9 depression
11 elevation
13 rear region
15 mounting for rear lights
17 rear body module
19 left-hand support
21 right-hand support
23 roof rail
25 front rail
27 rear rail
29 cross member
31 reinforcing strut
33 rail
35 backrest
37 seat shell
39 mounting for battery module
41 transportation box
43 roller
45 seat cross member

1: A rear body module, comprising:
a floor panel with at least one mounting for a rear seat and also an upwardly extending rear termination, depressions and elevations being formed in the floor panel for strengthening, and
a left-hand and a right-hand support, which in each case form a C pillar of a vehicle body and fork at their upper end into at least two rails, the rails being respectively connected to a rear roof rail, the roof rails being connected to one another by a cross member, and a reinforcing strut respectively emerging from the cross member and being coupled to the roof rail.

2: The rear body module according to claim 1, wherein a depression for receiving a battery module is formed under the mounting for the rear seat.

3: The rear body module according to claim 1, wherein two mountings for a rear seat are formed in the floor panel and a seat shell is fitted on each mounting.

4: The rear body module according to claim 1, wherein a further rail extends between a support and the roof rail, and a backrest of the rear seat is attached to the further rail.

5: The rear body module according to claim 1, wherein a transportation box is fitted on the mounting for the rear seat.

6: The rear body module according to claim 1, wherein the floor panel, the supports and/or the rails are reinforced by a wire mesh.

7: The rear body module according to claim 1, wherein the floor panel, the supports, the rails, the roof rails and/or the reinforcing struts (31) are produced from a material comprising plastic.

8: The rear body module according to claim 7, wherein the material comprising plastic is a fiber-reinforced plastic, an organometallic sheet or a sandwich structure.

9: The rear body module according to claim 7, wherein the plastic is polyurethane, polyamide, polybutylene terephthalate, polypropylene or epoxy resin.

10: The rear body module according to claim 8, wherein the material comprising plastic is a sandwich structure, which is made up of an upper and a lower sheet and also a polymer foam incorporated between the sheets or a honeycomb structure incorporated between the sheets.

11: The rear body module according to claim 10, wherein the upper and lower sheets are each independently an organometallic sheet.
